(19) United States
(12) Patent Application Publication
(10) Pub. No.: US 2026/0164282 A1
(43) Pub. Date: Jun. 11, 2026

(54) INFORMATION PROCESSING METHOD AND APPARATUS, AND COMMUNICATION SYSTEM, COMMUNICATION DEVICE AND STORAGE MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/126,762

(22) PCT Filed: Nov. 4, 2022
(86) PCT No.: PCT/CN2022/130148

§ 371 Date: May 2, 2025

(51) Int. Cl. H04W 24/10; H04B 17/318; H04W 64/00

(52) U.S. Cl. CPC H04W 24/10; H04B 17/318; H04W 64/006

(57) ABSTRACT

Provided in the embodiments of the present disclosure is an information processing method, which is applied to a network device. The method comprises: sending first information to a terminal, wherein the first information is used for the terminal to determine N associated measurement events, N being an integer greater than 1. In the embodiments of the present disclosure, the association of a plurality of measurement events can be realized by sending the first information, and the plurality of measurement events are associated with each other, so that the frequency of the terminal performing reporting can be reduced to a certain extent, and requirements of different measurement scenarios of the terminal are met.

### CROSS-REFERENCE TO RELATED APPLICATIONS

The present application is a U.S. National Stage of International Application No. PCT/CN2022/130148, filed on Nov. 4, 2022, the content of which is incorporated by reference herein in its entirety for all purposes.

### TECHNICAL FIELD

The present disclosure relates to the field of wireless communication technology but is not limited to the field of wireless communication technology, and in particular to information processing method and apparatus, a communication system, a communication device and a storage medium.

### BACKGROUND

In a mobile communication system, the movement of user equipment (UE) causes a change in the channel condition around it. In order to support the mobility of UE and obtain the channel condition of the cell around the UE in a timely manner, the network device configures the UE to perform radio resource management (RRM) measurement. The idle-state and inactive-state UEs autonomously select or reselect cells based on RRM measurement results, and the connected-state UE report RRM measurement results to the network device to assist the network device in making switching decisions.

During the measurement process of the connected-state UE, the network of the New Radio (NR) system sends measurement configuration information to the connected-state UE through radio resource control (RRC) signaling. The UE performs measurements of the same-frequency cell, different-frequency cell and/or different-system cell according to the measurement configuration information. The measurement results are then reported to the network device.

### SUMMARY

Embodiments of the present disclosure provide information processing method and apparatus, a communication device, and a storage medium.

According to a first aspect of the embodiments of the present disclosure, there is provided an information processing method, performed by a network device, including:
sending first information to a terminal, where the first information is used by the terminal to determine N associated measurement events, and N is an integer greater than 1.

According to a second aspect of the embodiments of the present disclosure, there is provided an information processing method, performed by a terminal, including:
receiving first information sent by a network device, where the first information is used by the terminal to determine associated N measurement events, and N is an integer greater than 1.

According to a third aspect of the embodiments of the present disclosure, there is provided an information processing method, including:
a network device sends first information to a terminal, where the first information is used by the terminal to determine N associated measurement events, and N is an integer greater than 1; and
the terminal receives the first information sent by the network device.

According to a fourth aspect of the embodiments of the present disclosure, there is provided an information processing device, including:
a first information module, configured to send first information to a terminal, where the first information is used by the terminal to determine N associated measurement events, and N is an integer greater than 1.

According to a fifth aspect of the embodiments of the present disclosure, there is provided an information processing device, including:
a receiving module, configured to receive first information sent by a network device, where the first information is used by the terminal to determine N associated measurement events, and N is an integer greater than 1.

According to a sixth aspect of the embodiments of the present disclosure, there is provided a wireless communication system, including:
a network device configured to send first information to a terminal, where the first information is used by the terminal to determine N associated measurement events, and N is an integer greater than 1; and
a terminal configured to receive the first information sent by the network device.

According to a seventh aspect of the embodiments of the present disclosure, there is provided a communication device, including a processor, a transceiver, a memory, and an executable program stored in the memory and capable of being run by the processor, where the processor executes the information processing method according to the above first or second aspect when running the executable program.

According to an eighth aspect of the embodiments of the present disclosure, there is provided a computer storage medium storing an executable program; after the executable program is executed by a processor, it can implement the information processing method according to the above first or second aspect.

The technical solution provided by the embodiment of the present disclosure should be understood that the above general description and the detailed description below are only exemplary and explanatory, and cannot limit the embodiment of the present disclosure.

### BRIEF DESCRIPTION OF THE DRAWINGS

The drawings herein are incorporated into the specification and constitute a part of the specification, showing the principles of the embodiments of the present disclosure and used together with the specification to explain the embodiments of the present disclosure.

FIG. 1 is a schematic diagram of a structure of a wireless communication system according to an example embodiment;

FIG. 2 is a schematic diagram of an information processing method according to an example embodiment;

FIG. 3 is a schematic diagram of another information processing method according to an example embodiment;

FIG. 4 is a schematic diagram of receiving a measurement report according to an example embodiment;

FIG. 5 is a schematic diagram of another information processing method according to an example embodiment;

FIG. 6 is a schematic diagram of another information processing method according to an example embodiment;

FIG. 7 is a schematic diagram of another information processing method according to an example embodiment;

FIG. 8 is a schematic diagram of another information processing method according to an example embodiment;

FIG. 9 is a schematic diagram of another information processing method according to an example embodiment;

FIG. 10 is a schematic diagram of another information processing method according to an example embodiment;

FIG. 11 is a schematic diagram of reporting a measurement report according to an example embodiment;

FIG. 12 is a schematic diagram of an information processing device according to an example embodiment;

FIG. 13 is a schematic diagram of another information processing device according to an example embodiment;

FIG. 14 is a schematic diagram of a wireless communication system according to an example embodiment;

FIG. 15 is a schematic diagram of a measurement process according to an example embodiment;

FIG. 16 is a schematic diagram of a structure of a UE according to an example embodiment; and

FIG. 17 is a schematic diagram of a structure of a communication device according to an example embodiment.

### DETAILED DESCRIPTION

Here, example embodiments will be described in detail, and examples thereof are shown in the accompanying drawings. When the following description refers to the drawings, unless otherwise indicated, the same numbers in different drawings represent the same or similar elements. The embodiments described in the following example embodiments do not represent all embodiments consistent with the embodiments of the present disclosure. Instead, they are only examples of devices and methods consistent with some aspects of the embodiments of the present disclosure.

The terms used in the embodiments of the present disclosure are only for the purpose of describing specific embodiments and are not intended to limit the embodiments of the present disclosure. The singular forms of “a”, “an”, “said” and “the” used in the present disclosure are also intended to include plural forms unless the context clearly indicates other meanings. It should also be understood that the term “and/or” used herein refers to and includes any or all possible combinations of one or more associated listed items.

It should be understood that although the terms first, second, third, etc. may be used in the embodiments of the present disclosure to describe various information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “at . . . ” or “when . . . ” or “in response to determining”.

Please refer to FIG. 1, which shows a schematic diagram of a structure of a wireless communication system provided by an embodiment of the present disclosure. As shown in FIG. 1, the wireless communication system is a communication system based on cellular mobile communication technology, and the wireless communication system may include at least one UE 11 and some core network devices.

UE 11 can be a device that provides voice and/or data connectivity to users. UE 11 can communicate with one or more core networks via a radio access network (RAN). UE 11 can be an Internet of Things UE, such as a sensor device, a mobile phone (or a “cellular” phone), and a computer with an Internet of Things UE. For example, it can be a fixed, portable, pocket-sized, handheld, computer-built-in or vehicle-mounted device. For example, it can be a station (STA), a subscriber unit, a subscriber station, a mobile station, a mobile, a remote station, an access point, a remote terminal, an access terminal, a user terminal, a user agent, a user device, or user equipment, UE. Alternatively, UE 11 may also be a device of an unmanned aerial vehicle. Alternatively, UE 11 may also be a vehicle-mounted device, such as a driving computer with wireless communication function, or a wireless communication device connected to an external driving computer. Alternatively, UE 11 may also be a roadside device, such as a street lamp, signal lamp or other roadside device with wireless communication function.

Access device 12 may be a network-side device in a wireless communication system. The wireless communication system may be a 4th generation mobile communication technology (4G) system, also known as a long term evolution (LTE) system. Or, the wireless communication system may be a 5G system, also known as a new radio (NR) system or a 5G NR system. Alternatively, the wireless communication system may be a next generation system of the 5G system. The access network in the 5G system may be called NG-RAN (New Generation-Radio Access Network). Alternatively, the wireless communication system may be an MTC system.

The access device 12 may be an evolved access device (eNB) used in a 4G system. Alternatively, the access device 12 may also be an access device (gNB) using a centralized distributed architecture in a 5G system. When the access device 12 uses a centralized distributed architecture, it generally includes a central unit (CU) and at least two distributed units (DUs). The central unit is provided with a protocol stack of a Packet Data Convergence Protocol (PDCP) layer, a Radio Link Control (RLC) layer, and a Media Access Control (MAC) layer. The distributed unit is provided with a Physical (PHY) layer protocol stack. The specific implementation of the access device 12 is not limited in the embodiments of the present disclosure.

A wireless connection can be established between the access device 12 and the UE 11 through a wireless air interface. In different implementations, the wireless air interface is a wireless air interface based on the fourth generation mobile communication network technology (4G) standard. Or, the wireless air interface is a wireless air interface based on the fifth generation mobile communication network technology (5G) standard, for example, the wireless air interface is a new radio. Or, the wireless air interface can also be a wireless air interface based on the next generation mobile communication network technology standard of 5G.

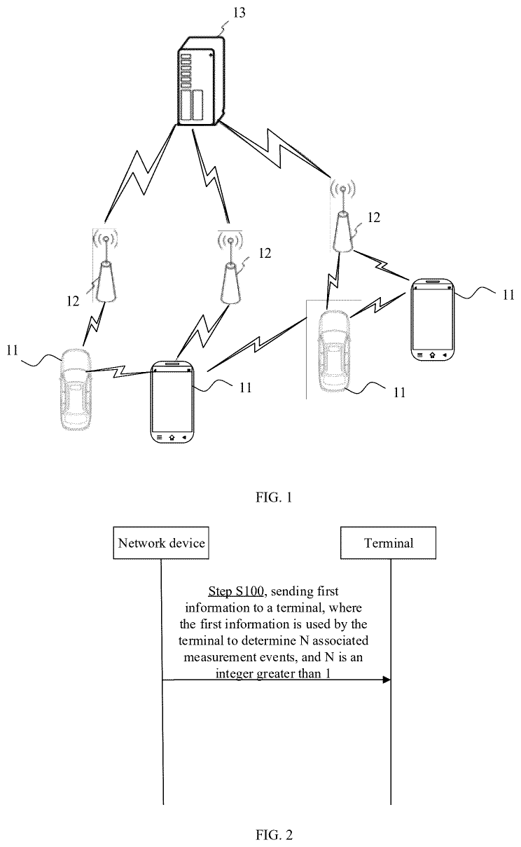

In one embodiment, referring to FIG. 2, a schematic diagram of an information processing method is provided. The method is applied to a network device, and the method includes:
Step S100, sending first information to a terminal, where the first information is used by the terminal to determine N associated measurement events, and N is an integer greater than 1.

For example, the network device may include a base station, and the base station may be an evolved node base station (eNB), or a network device in a 5G system, such as a next generation node base station (gNB), or a transmission and reception point (TRP) or other device, or a network device in a subsequent evolutionary communication system.

The first information is information used by the terminal to determine N associated measurement events.

For example, the first information may be a type of information included in the measurement configuration information.

Again for example, the first information may be a type of information independent of the measurement configuration information.

The measurement configuration information may be any information for regulating the behavior of the terminal's measurement and reporting.

For example, the measurement configuration information may include one or more of measurement object configuration, measurement identification, measurement event configuration, and measurement reporting configuration. The measurement object configuration defines frequency and/or time domain resources to be measured. The measurement identification is configured to associate the measurement object and the reporting configuration. The measurement event is configured to determine a specific event to be evaluated for the current measurement result. The measurement reporting configuration can be configured to define the content of the measurement report containing the measurement result, and the measurement reporting configuration can include the configuration of the measurement event.

In short, the specific content of the first information is not limited in this embodiment, and the information that can be used by the terminal to determine the associated N measurement events is within the protection scope of this embodiment.

The first information can be carried by various high-level signaling. The high-level signaling includes but is not limited to RRC signaling and/or MAC CE. The above is only an example of the message carried by the first information and the message carried by the first information is not limited to the above example, and the specific message format is not specifically defined here.

The association of N measurement events is realized through the first information, which meets the use requirement of associating two or more measurement events. By sending the first information to the terminal, the requirement of sending the information of N associated measurement events to the terminal can be realized. On the other hand, such first information can support the terminal to perform measurement reporting according to N measurement events.

In one implementation, the measurement event may be one or more of the following measurement events: a first type of measurement event and/or a second type of measurement event.

For example, the first type of measurement event may be a measurement event related to a terminal. The second type of measurement event may be a measurement event related to a cell.

The first type of measurement event includes at least one of the following:
a measurement event based on height: such as events H1˜H2;
a measurement event based on location, such as event D1;
a measurement event based on time, such as event T1; and
a measurement event based on speed.

The second type of measurement event includes at least:
a measurement event based on signal strength; such as events A1˜A6.

The associated N measurement events may all be the first type of measurement events, or all be the second type of measurement events, or include both the first type of measurement events and the second type of measurement events.

There may be one or more categories of the first type of measurement events associated in the N measurement events. For example, the N associated measurement events may include one or more of a measurement event based on height, a measurement event based on location, a measurement event based on time, and a measurement event based on speed.

There may be one or more categories of the second type of measurement events associated in the N measurement events. For example, the N associated measurement events may include one or more of events A1 to A6, and events B1 to B2.

In one embodiment, the measurement events may include measurement events A1, A2, A3, A4, A5, A6 in the RRM events supported by the NR system, and measurement events B1 and B2 of different RATs.

The conditions for meeting each measurement event are as follows:
Measurement event A1: the measurement result of the serving cell is greater than the threshold; measurement event A2: the measurement result of the serving cell is less than the threshold; measurement event A3: the measurement result of the neighboring cell is better than the measurement result of the special cell (SpCell), and the SpCell includes the primary cell (PCell) or the primary secondary cell (PSCell); A4: the measurement result of the neighboring cell is greater than the threshold; A5: the SpCell measurement result is less than threshold 1, and the measurement result of the neighboring cell is greater than threshold 2; A6: the measurement result of the neighboring cell is better than the measurement result of a secondary cell (SCell); B1: the measurement result of the neighboring cell of the different system is greater than the threshold; B2: the measurement result of the primary serving cell is less than threshold 1, and the measurement result of the neighboring cell of the different system is greater than threshold 2.

The threshold value corresponding to each threshold can be determined according to the use requirement.

In one embodiment, the first information includes:
first measurement configuration information, where one piece of the first measurement configuration information is associated with the configuration information of N measurement events.

The one piece of the first measurement configuration information being associated with the configuration information of N measurement events may include:
configuration information associated with N measurement events;
and/or,
one configuration in the first measurement configuration information is associated with configuration information of N measurement events, and the configuration information of the N measurement events may belong to the first measurement configuration or not belong to the first measurement configuration.

In one embodiment, the first information includes:
indication information for indicating the association between M pieces of the second measurement configuration information, where one piece of the second measurement configuration information is associated with configuration information of one measurement event; M is an integer greater than 1.

One piece of the second measurement configuration information includes configuration information of one measurement event, and the indication information indicates the association between multiple pieces of the second measurement configuration information, thereby indicating the association between multiple measurement events.

Through the association relationship among the indication information, the second measurement configuration information and the configuration information of the measurement event, the use requirement of indicating associated multiple measurement events by one piece of indication information is realized, thereby meeting the use requirement of associating N measurement event, and sending the indication information to the terminal can realize sending the information of multiple measurement events to the terminal. On the other hand, such first information can support the terminal to perform measurement reporting according to multiple measurement events.

This embodiment can be implemented alone or in combination with the embodiment shown in FIG. 2 above.

In one embodiment, the first measurement configuration information includes:
a measurement identification;
an identification of a measurement object,
an identification of a reporting configuration group, where one reporting configuration group includes N reporting configurations, and one reporting configuration corresponds to one measurement event.

Different measurements correspond to different measurement identifications, and the measurements are performed according to the association relationship of the measurement identifications and the measurement identifications are sent to the terminal by the network device. One measurement identification is associated with an identification of a measurement object and an identification of a reporting configuration group at the same time, indicating a combination of the identifications of the measurement object to be measured and the reporting configuration group.

Different measurements may have different reference signals to be measured and/or different time-frequency domain positions of the reference signals to be measured.

Because one reporting configuration group identification, one reporting configuration group includes N reporting configurations, and one reporting configuration corresponds to one measurement event, the association of multiple measurement events is realized through the first measurement configuration information, and the association of N measurement events can be realized through an identification of one reporting configuration group, thereby meeting the use requirement of associating N measurement events, and sending the indication information to the terminal can realize the sending of the information of the associated N measurement events to the terminal.

This embodiment can be implemented alone or in combination with the embodiment shown in FIG. 2.

In one embodiment, a measurement identification is associated with an identification of a reporting configuration group, a measurement identification is associated with multiple reporting configurations, and a measurement identification is associated with an identification of a measurement object.

In one embodiment, a measurement identification is associated with an identification of a measurement object and an identification of a reporting configuration, and the reporting configuration group indicated by the identification of the reporting configuration includes two reporting configurations.

In one embodiment, the measurement identification is a measurement identification used to configure a joint configuration of multiple measurement events.

In one embodiment, the association includes direct association and indirect association.

In one embodiment, the first measurement configuration information includes:
a measurement identification;
an identification of a measurement object;
an identification of a reporting configuration, indicating a reporting configuration; where one reporting configuration corresponds to N measurement events.

Because an identification of one reporting configuration indicates one reporting configuration, and one reporting configuration corresponds to one measurement event, the association of multiple measurement events is realized through the first measurement configuration information, and the association of N measurement events can be realized through an identification of one reporting configuration, thereby meeting the use requirement of associating N measurement events, and sending the indication information to the terminal can realize the sending of the configuration information of multiple measurement events to the terminal.

This embodiment can be implemented alone or in combination with the embodiment shown in FIG. 2.

In one embodiment, one reporting configuration corresponds to two measurement events.

In one embodiment, one reporting configuration corresponds to a second type of measurement event and a first type of measurement event.

In one embodiment, one measurement identification is associated with an identification of one measurement object and identifications of multiple reporting configurations.

In one embodiment, the forms of the measurement identification, the identification of the measurement object and the identification of the reporting configuration are not limited, including ID and character string, etc. The measurement object can be determined according to actual use requirement, such as beam and frequency point, etc.

This embodiment can be implemented alone or in combination with the embodiment shown in FIG. 2.

In one embodiment, the measurement event includes:
a second type of measurement event and/or a first type of measurement event. The second type of measurement event includes an event in which the measured cell meets a certain signal strength, including a preset signal strength threshold. The signal strength includes at least the strength of the reference signal receiving power (RSRP), the strength of the LTE reference signal receiving quality (RSRQ), the RRM event supported in the NR system, and the heterogeneous system event supported in the NR system, etc.

The first type of measurement event includes at least one of the following:
a measurement event based on height;
a measurement event based on speed;
a measurement event based on time; and
a measurement event based on location.

Height, speed, time and location are the height, speed, time and location of the terminal. The height includes a relative height, such as a reference height based on sea level. The speed includes a relative speed, the time includes relative time and absolute time, and the location includes a relative location and an absolute location, etc.

For an event measured based on a preset reference height, if the terminal meets the event based on the preset reference height, it meets the first type of measurement event. For an event measured based on a preset reference speed, if the terminal meets the event based on the preset reference speed, it meets the first type of measurement event. For an event measured based on a preset reference time, if the terminal meets the event based on the preset reference time, it meets the first type of measurement event. For an event measured based on a preset reference location, if the terminal meets the event based on the preset reference location, it meets the first type of measurement event.

The associated N measurement events may all be the first type of measurement events, or all be the second type of measurement events, or include both the first type of measurement events and the second type of measurement events.

There may be one or more categories of the first type of measurement events associated in the N measurement events. For example, the N associated measurement events may include one or more of a measurement event based on height, a measurement event based on location, a measurement event based on time, and a measurement event based on speed.

There may be one or more categories of the second type of measurement events associated in the N measurement events. For example, the N associated measurement events may include one or more of events A1 to A6, and events B1 to B2.

In one embodiment, the second type of measurement events may at least include measurement events may include measurement events A1, A2, A3, A4, A5, A6 in RRM events supported by the NR system, and measurement events B1 and B2 of different RATs.

The measurement event based on height is an event determined according to a height of the terminal, where the height includes a height based on sea level.

In one embodiment, the first type of measurement events may be used for terminals with height, such as aircraft, and the second type of measurement events are applied to cells.

This embodiment may be implemented alone or in combination with the embodiment shown in FIG. 2.

In one embodiment, the indication information includes:
N measurement identifications; where one measurement identification is associated with one measurement event, and N measurement events associated with the N measurement identifications in the same indication information are associated.

N measurement identifications can be sent to the terminal through the indication information, because one measurement identification is associated with one measurement event, and the N measurement events associated with the N measurement identifications in the same indication information are associated, so the information of the N associated measurement events can be sent to the terminal by sending the indication information.

This embodiment can be implemented alone, or it can be implemented in combination with the embodiment shown in FIG. 2.

In one embodiment, the indication information includes:
N reporting configuration identifications, where one reporting configuration identification is associated with one measurement event, and the N measurement events associated with the N reporting configuration identifications in the same indication information are associated.

The N reporting configuration identifications can be sent to the terminal through the indication information. Since one reporting configuration identification is associated with one measurement event, and the N measurement events associated with the N reporting configuration identifications in the same indication information are associated, the information of the N associated measurement events can be sent to the terminal by sending the indication information.

This embodiment can be implemented alone or in combination with the embodiment shown in FIG. 2.

In one embodiment, the indication information includes:
N measurement event identifications indicating one measurement event; the N measurement events indicated by the identifications of the N measurement events in the same indication information are associated.

The identifications of the N measurement events can be sent to the terminal through the indication information. Since one measurement event identification indicates one measurement event, and the N measurement events indicated by the identifications of the N measurement events in the same indication information are associated, the information of the N associated measurement events can be sent to the terminal by sending the indication information.

This embodiment can be implemented alone or in combination with the embodiment shown in FIG. 2.

In one embodiment, the indication information includes:
configuration information of N measurement events; the measurement events indicated by the configuration information of the N measurement events in the same indication information are related.

The identifications of the N measurement events can be sent to the terminal through the indication information. Since configuration information of one measurement event corresponds to one measurement event, and configuration information of N measurement events in the same indication information is associated, the information of the N associated measurement events can be sent to the terminal by sending the indication information.

This embodiment can be implemented alone or in combination with the embodiment shown in FIG. 2.

In one embodiment, the joint configuration of multiple measurement events can be implemented by associating multiple reporting configurations with one measurement identification, where each reporting configuration corresponds to one measurement event and one measurement identification is associated with multiple reporting configurations.

In one embodiment, a group of joint configuration information includes one measurement identification, multiple reporting configurations and one measurement object. One measurement identification can associate multiple reporting configurations with one measurement object.

In one embodiment, one measurement identification is associated with one measurement object and one set of reporting configurations.

In one embodiment, one measurement identification is associated with one measurement object and two reporting configurations. The association here includes direct association or indirect association.

In one embodiment, the measurement identification may be a measurement identification dedicated to configuring the joint configuration of multiple measurement events.

In one embodiment, the joint configuration of multiple measurement events may be implemented by including configurations of multiple measurement events in one reporting configuration.

In one embodiment, a group of joint configuration information includes one measurement identification, one reporting configuration and one measurement object. The measurement identification associates one reporting configuration with one measurement object. The reporting configuration may include the configurations of multiple measurement events.

In one embodiment, one reporting configuration may include configuration information of a group of events.

In one embodiment, one reporting configuration may include configuration information of two events.

In one embodiment, for example, one event is a second type of measurement event; one event is a first type of measurement event.

In one embodiment, the joint configuration of multiple measurement events may be implemented by indication information, and the indication information may be configured to indicate one or more associated measurement events, including at least one of:
the indication information indicates one or more measurement identifications;
the indication information indicates identifications of one or more reporting configurations;
the indication information includes identifications or configurations of one or more events.

For the indication information, the identifications of the multiple reporting configurations used for indication are all associated with the same measurement object.

For the indication information, multiple measurement identifications used for indication are associated with the same measurement object and different reporting configurations.

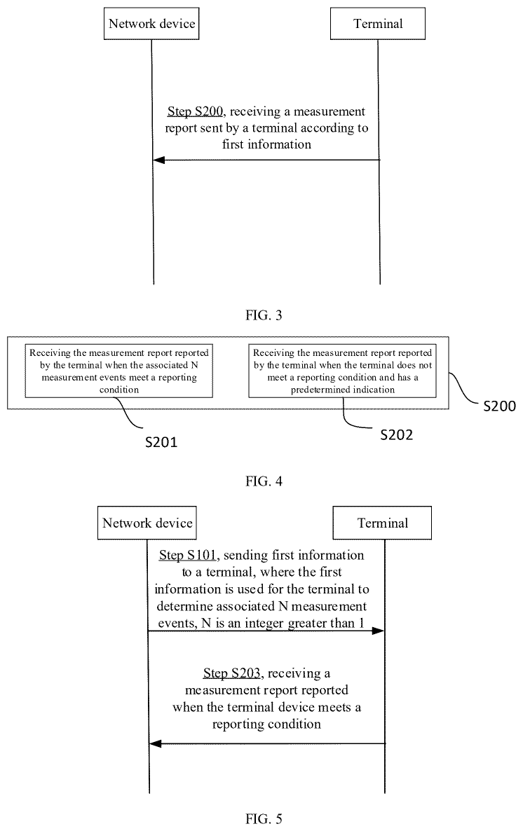

In one embodiment, referring to FIG. 3, FIG. 3 is a schematic diagram of another information processing method, and the method further includes:
Step S200, receiving a measurement report sent by a terminal according to first information.

After the network device sends the first information to the terminal, the network device can also receive the measurement report sent by the terminal according to the first information.

This embodiment can be implemented alone or in combination with the embodiment shown in FIG. 2.

In one embodiment, the measurement report includes at least one of:
a measurement identification;
for example, the measurement report may include measurement identifications corresponding to one or more associated measurement configurations, or one or more associated measurement identifications.

a serving cell of the terminal; the serving cell of the terminal may include a primary cell and/or a secondary cell;
a neighboring cell with the best measurement result on each serving frequency point;
a neighboring cell that meets the triggering condition of the measurement event.

The network device can determine the measurement object corresponding to the measurement report, the threshold corresponding to the event-triggered measurement event, the periodic triggering purpose and the like according to the measurement identification in the measurement report and the measurement configuration information stored by the network device.

For example: the measurement report includes one or more measurement identifications corresponding to multiple measurement events configured jointly and/or indication information for indicating the currently satisfied measurement event.

This embodiment can be implemented alone or in combination with the embodiments shown in FIG. 2 to FIG. 3.

In one embodiment, referring to FIG. 4, FIG. 4 is a schematic diagram of receiving a measurement report. Step S200, receiving the measurement report sent by the terminal according to the first information includes:
step S201, receiving the measurement report reported when the terminal device meets a reporting condition;
or
step S202, receiving the measurement report sent when the terminal has a predetermined indication.

The reporting condition can be determined according to actual use requirement, such as the number of satisfied measurement events. The predetermined indication can be information carried in the second measurement configuration information. The predetermined indication may include but is not limited to reportonleave, etc.

For example, if the measurement report is triggered by a predetermined indication (reportonleave), the measurement report includes the measurement event identification of the unsatisfied measurement event and/or indication information indicating that this report is triggered by the predetermined indication.

This embodiment can be implemented alone or in combination with the embodiments shown in the above-mentioned FIG. 2 to FIG. 3.

In one embodiment, refer to FIG. 5, which is a schematic diagram of another information processing method, the method includes:
Step S101, sending first information to a terminal, where the first information is used for the terminal to determine associated N measurement events, N is an integer greater than 1.

In one embodiment, the UE can determine the associated multiple events according to any configuration method of the above-mentioned embodiments.

In one embodiment, for a measurement identification, if it is associated with multiple reporting configurations, then configuration information of a corresponding measurement event can be obtained according to each reporting configuration.

In one embodiment, the UE can obtain configuration information of the corresponding measurement event according to the reporting configuration containing the configuration information of multiple measurement events.

In one embodiment, the UE can obtain reporting configuration corresponding to each measurement identification according to the multiple measurement identifications indicated by the indication information, and each reporting configuration contains configuration information of one measurement event.

In one embodiment, the UE can obtain configuration information of one measurement event contained in each reporting configuration according to the identifications of the multiple reporting configurations indicated by the indication information.

Step S203, receiving a measurement report reported when the terminal device meets a reporting condition.

This embodiment can be implemented alone or in combination with the embodiments shown in the above-mentioned FIG. 2 to FIG. 4.

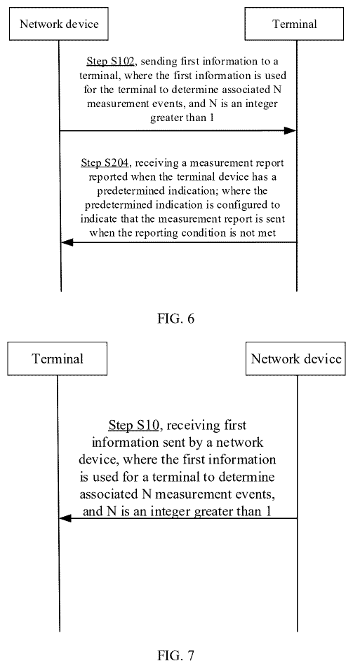

In one embodiment, referring to FIG. 6, FIG. 6 is a schematic diagram of another information processing method, the method includes:
Step S102, sending first information to a terminal, where the first information is used for the terminal to determine associated N measurement events, and N is an integer greater than 1.

In one embodiment, the UE can determine the associated multiple events according to any configuration method of the above-mentioned embodiments.

In one embodiment, for a measurement identification, if it is associated with multiple reporting configurations, then configuration information of a corresponding measurement event can be obtained according to each reporting configuration.

In one embodiment, the UE can obtain the configuration information of the corresponding measurement event according to the reporting configuration containing the configuration information of multiple measurement events.

In one embodiment, the UE can obtain reporting configuration corresponding to each measurement identification according to the multiple measurement identifications indicated by the indication information, and each reporting configuration contains configuration information of one measurement event.

In one embodiment, the UE can obtain the configuration information of one measurement event contained in each reporting configuration according to the identifications of the multiple reporting configurations indicated by the indication information.

Step S204, receiving a measurement report reported when the terminal device has a predetermined indication; where the predetermined indication is configured to indicate that the measurement report is sent when the reporting condition is not met.

This embodiment can be implemented alone or in combination with the embodiments shown in FIG. 2 to FIG. 4 above.

In one embodiment, N measurement events meeting the reporting condition includes at least one of:
meeting any one of the N measurement events;
meeting all of the N measurement events;
meeting a predetermined number of events in the N measurement events.

The predetermined number can be determined according to actual use requirement, and the preset number is less than N.

This embodiment can be implemented alone or in combination with the embodiments shown in FIG. 2 to FIG. 6 above.

In one embodiment, not meeting the reporting condition includes at least one of:
not meeting any one of the N measurement events;
not meeting all of the N measurement events;
not meeting a predetermined number of measurement events in the N measurement events.

This embodiment can be implemented alone or in combination with the embodiments shown in FIG. 2 to FIG. 6 above.

In one embodiment, N measurement events include one or more first type of measurement events; and one or more second type of measurement events;
N measurement events meeting the reporting condition includes:
the terminal meets the first type of measurement event, and one or more cells measured meet the second type of measurement event;
or
the terminal meets the first type of measurement event.

In one case, the terminal meets the first type of measurement event alone and the reporting condition is met. In another case, the terminal meets the first type of measurement event and one or more cells measured meet the second type of measurement event, and the reporting condition is met.

This embodiment can be implemented alone or in combination with the embodiments shown in FIG. 2 to FIG. 6 above.

In one embodiment, not meeting the reporting condition includes at least one of:
not meeting the second type of measurement event;
the terminal not meeting the first type of measurement event.

This embodiment can be implemented alone or in combination with the embodiments shown in FIG. 2 to FIG. 6 above.

In one embodiment, the measurement event includes:
an entry condition, for the terminal to detect a parameter value that meets the measurement event within the configured trigger time and determine that the measurement event is met;
an exit condition, for the terminal to detect a parameter value that does not meet the measurement event within the configured trigger time and determine that the measurement event is not met.

The trigger time, the parameter value that meets the measurement event, and the parameter value that does not meet the measurement event can be determined according to the actual use requirement and can be determined according to the configuration parameters.

For example, meeting the measurement event means meeting the entry condition of the corresponding measurement event within the configured trigger time.

For example, not meeting the measurement event means meeting the exit condition of the corresponding measurement event within the configured trigger time.

This embodiment can be implemented alone or in combination with the embodiments shown in FIG. 2 to FIG. 6 above.

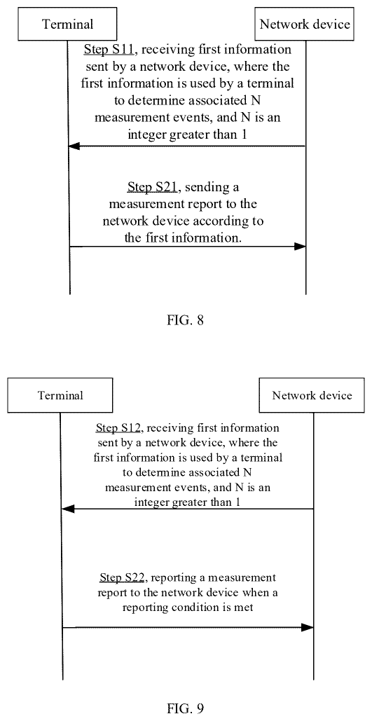

In one embodiment, referring to FIG. 7, FIG. 7 is a schematic diagram of another information processing method, which is applied to a terminal, and the method includes:
Step S10, receiving first information sent by a network device, where the first information is used for a terminal to determine associated N measurement events, and N is an integer greater than 1.

The terminal includes UE 11 as shown in FIG. 1, a mobile phone, a tablet computer, a laptop computer, an ultra-mobile personal computer (UMPC), a netbook, or a personal digital assistant (PDA), etc. The terminal also includes equipment for unmanned aerial vehicles.

The first information is information used by the terminal to determine the associated N measurement events. The content of the first information is not limited in this embodiment, and the information that can be used by the terminal to determine the associated N measurement events is within the protection scope of this embodiment.

In one embodiment, the first information includes measurement configuration information of N measurement events, indication signaling indicating the configuration information of N measurement events, etc.

For example, the measurement configuration information may include one or more of a measurement object configuration, a measurement identification, a measurement event configuration, and a measurement report configuration. The measurement object configuration defines the frequency and/or time domain resources to be measured. The measurement identification is configured to associate the measurement object and the report configuration. The measurement event is configured to determine a specific event to be evaluated for the current measurement result. The measurement report configuration can be configured to define the content of the measurement report containing the measurement result, and the measurement report configuration can include the configuration of the measurement event.

The first information realizes the association of N measurement events and meets the use requirement of associating two or more measurement events. According to the first information, the measurement of N associated measurement events and the requirement of sending the measurement results of N associated measurement events to the network device can be realized, and the measurement report according to N measurement events can be realized.

In one implementation, the measurement event may be one or more of the following measurement events:
a second type of measurement event; such as events A1 to A6.
a first type of measurement event, including at least one of the following:
a measurement event based on height: such as events H1 to H2;
a measurement event based on location, such as event D1;
a measurement event based on time, such as event T1.
a measurement event based on speed.

The associated N measurement events may all be the first type of measurement events, or all be the second type of measurement events, or include both the first type of measurement events and the second type of measurement events.

There may be one or more categories of the first type of measurement events associated in the N measurement events. For example, the N associated measurement events may include one or more of a measurement event based on height, a measurement event based on location, a measurement event based on time, and a measurement event based on speed.

There may be one or more categories of the second type of measurement events associated in the N measurement events. For example, the N associated measurement events may include one or more of events A1 to A6, and events B1 to B2.

This embodiment may be implemented alone or in combination with the embodiments shown in FIG. 2 to FIG. 6 above.

In one embodiment, the measurement events may include measurement events A1, A2, A3, A4, A5, A6 in the RRM events supported by the NR system, and measurement events B1 and B2 of different RATs.

The conditions for meeting each measurement event are as follows:
Measurement event A1: the measurement result of the serving cell is greater than the threshold; Measurement event A2: the measurement result of the serving cell is less than the threshold; Measurement event A3: the measurement result of the neighboring cell is better than the measurement result of the special cell (SpCell), and the SpCell includes the primary cell (PCell) or the primary secondary cell (PSCell); A4: the measurement result of the neighboring cell is greater than the threshold; A5: the SpCell measurement result is less than threshold 1, and the measurement result of the neighboring cell is greater than threshold 2; A6: the measurement result of the neighboring cell is better than the measurement result of a secondary cell (SCell); B1: the measurement result of the neighboring cell of the different system is greater than the threshold; B2: the measurement result of the primary serving cell is less than threshold 1, and the measurement result of the neighboring cell of the different RAT is greater than threshold 2.

In one embodiment, the first information includes:
first measurement configuration information, where one piece of the first measurement configuration information is associated with configuration information of N measurement events.

One piece of measurement configuration information can jointly configure N measurement events. That is, one piece of measurement configuration information includes configuration information of N measurement events. The measurement of the N associated measurement events and the requirement of sending the measurement results of the N associated measurement events to the network device can be realized according to the first information, thereby realizing measurement reporting according to N measurement events.

In one embodiment, there may be multiple pieces of the first information.

In one embodiment, the first information includes:
indication information for indicating the association between second measurement configuration information, where one piece of the second measurement configuration information is associated with configuration information of one measurement event.

One piece of the second measurement configuration information includes configuration information of one measurement event, and the indication information indicates the association between multiple pieces of second measurement configuration information, thereby indicating the association of multiple measurement events. Through the association relationship between the indication information, the second measurement configuration information and the configuration information of the measurement event, the measurement of the N associated measurement events and the requirement of sending the measurement results of the N associated measurement events to the network device can be realized according to the first information, thereby realizing measurement reporting according to N measurement events.

In one embodiment, the first measurement configuration information includes:
a measurement identification;
an identification of a measurement object,
an identification of a reporting configuration group, wherein one reporting configuration group includes N reporting configurations, and one reporting configuration corresponds to one measurement event.

Different measurements correspond to different measurement identifications, and the measurement identification are sent to the terminal by the network device. One measurement identification is associated with an identification of a measurement object and an identification of a reporting configuration group at the same time, indicating a combination of identifications of the measurement object to be measured and the reporting configuration group.

In some embodiments, the measurement object includes a frequency point, a carrier and/or a beam, etc.

Because an identification of a reporting configuration group, one reporting configuration group includes N reporting configurations, and one reporting configuration corresponds to one measurement event, the association of multiple measurement events is realized through the first measurement configuration information, and the measurement of the N associated measurement events and the requirement of sending the measurement results of the N associated measurement events to the network device can be realized according to the first information, thereby realizing measurement reporting according to N measurement events.

In one embodiment, one measurement identification is associated with an identification of one reporting configuration group, one measurement identification is associated with multiple reporting configurations, and one measurement identification is associated with an identification of one measurement object.

In one embodiment, one measurement identification is associated with an identification of one measurement object and an identification of one reporting configuration, and a reporting configuration group indicated by the identification of the reporting configuration includes two reporting configurations.

In one embodiment, the association includes direct association and indirect association.

In one embodiment, the first measurement configuration information includes:
a measurement identification;
an identification of a measurement object;
an identification of a reporting configuration, indicating one reporting configuration; where one reporting configuration corresponds to N measurement events.

Because an identification of one reporting configuration indicates one reporting configuration, and one reporting configuration corresponds to one measurement event, the association of multiple measurement events is realized through the first measurement configuration information, and the measurement of N associated measurement events and the requirement of sending the measurement results of N associated measurement events to the network device can be realized according to the first information, thereby realizing measurement reporting according to N measurement events.

In one embodiment, one reporting configuration corresponds to two measurement events.

In one embodiment, one reporting configuration corresponds to the second type of measurement event and the first type of measurement event.

In one embodiment, one measurement identification is associated with an identification of one measurement object and identifications of multiple reporting configurations.

In one embodiment, the forms of the measurement identification, the identification of the measurement object and the identification of the reporting configuration are not limited, including ID and character string, etc. The measurement object can be determined according to the actual use requirement, such as beam and frequency point, etc.

In one embodiment, determining the associated N measurement events includes:
determining the associated N measurement events according to the reporting configuration group associating the N measurement events.

When a reporting configuration group includes N reporting configurations and one reporting configuration corresponds to one measurement event, the reporting configuration group associates the N measurement events, and the associated N measurement events can be determined according to the reporting configuration group.

In one embodiment, determining the associated N measurement events includes:
determining the associated N measurement events according to the reporting configuration associating the N measurement events.

When one reporting configuration corresponds to N measurement events, the associated N measurement events can be determined according to the reporting configuration.

In one embodiment, the measurement event includes:
a second type of measurement event and/or a first type of measurement event. The second type of measurement event include an event in which the measured cell meets a certain signal strength, including a preset signal strength threshold. The signal strength includes at least the strength of the reference signal receiving power (RSRP), the strength of the LTE reference signal receiving quality (RSRQ), the RRM events supported in the NR system, and the heterogeneous system events supported in the NR system, etc.

The first type of measurement event includes at least one of the following:
a measurement event based on height;
a measurement event based on speed;
a measurement event based on time; and
a measurement event based on location.

Height, speed, time and location are the height, speed, time and location of the terminal. The height includes a relative height, such as a reference height based on sea level. The speed includes a relative speed, the time includes relative time and absolute time, and the location includes a relative location and an absolute location, etc.

The second type of measurement events may at least include: the measurement events may include measurement events A1, A2, A3, A4, A5, A6 in the RRM events supported by the NR system, and measurement events B1 and B2 of different RATs.

The measurement event based on height is an event determined according to a height of the terminal, and the height here includes a height based on sea level.

For an event measured based on a preset reference height, if the terminal meets the event based on the preset reference height, it meets the first type of measurement event. For an event measured based on a preset reference speed, if the terminal meets the event based on the preset reference speed, it meets the first type of measurement event. For an event measured based on a preset reference time, if the terminal meets the event based on the preset reference time, it meets the first type of measurement event. For an event measured based on a preset reference location, if the terminal meets an event based on the preset reference location, it meets the first type of measurement event.

The associated N measurement events may all be the first type of measurement events, or all be the second type of measurement events, or include both the first type of measurement events and the second type of measurement events.

There may be one or more categories of the first type of measurement events associated in the N measurement events. For example, the N associated measurement events may include one or more of a measurement event based on height, a measurement event based on location, a measurement event based on time, and a measurement event based on speed.

There may be one or more categories of the second type of measurement events associated in the N measurement events. For example, the N associated measurement events may include one or more of events A1 to A6, and events B1 to B2.

In one embodiment, the indication information includes:
N measurement identifications; where one measurement identification is associated with one measurement event, and N measurement events associated with the N measurement identifications in the same indication information are associated.

The N measurement identifications can be sent to the terminal by the indication information. Since one measurement identification is associated with one measurement event, and the N measurement events associated with the N measurement identifications in the same indication information are associated, the measurement of the N associated measurement events can be realized according to the first information, and the requirement for sending the measurement results of the N associated measurement events to the network device can be realized, thereby realizing the measurement reporting according to the N measurement events.

In one embodiment, the indication information includes:
N reporting configuration identifications, where one reporting configuration identification is associated with one measurement event, and the N measurement events associated with the N reporting configuration identifications in the same indication information are associated.

The N reporting configuration identifications can be sent to the terminal through the indication information. Since one reporting configuration identification is associated with one measurement event, and the N measurement events associated with the N reporting configuration identifications in the same indication information are associated, the measurement of the N associated measurement events and the requirement of sending the measurement results of the N associated measurement events to the network device can be realized according to the first information, thereby realizing measurement reporting according to the N measurement events.

In one embodiment, the indication information includes:
N measurement event identifications indicating one measurement event; the N measurement events indicated by the identifications of the N measurement events in the same indication information are associated.

The identifications of the N measurement events can be sent to the terminal through the indication information. Since one measurement event identification indicates one measurement event, and the N measurement events indicated by the identifications of the N measurement events in the same indication information are associated, the measurement of the N associated measurement events and the requirement of sending the measurement results of the N associated measurement events to the network device can be realized according to the first information, thereby realizing the measurement reporting according to the N measurement events.

In one embodiment, the indication information includes:
configuration information of N measurement event; the measurement events indicated by the configuration information of the N measurement events in the same indication information are related.

The identifications of the N measurement events can be sent to the terminal through the indication information. Since configuration information of one measurement event corresponds to one measurement event, and configuration information of N measurement events in the same indication information has an associated relationship, the measurement of the N associated measurement events and the requirement of sending the measurement results of the N associated measurement events to the network device can be realized according to the first information, thereby realizing the measurement reporting according to the N measurement events.

In one embodiment, for a measurement identification, if it is associated with multiple reporting configurations, then configuration information of a corresponding measurement event can be obtained according to each reporting configuration.

In one embodiment, the UE can obtain the configuration information of the corresponding measurement event according to the reporting configuration containing the configuration information of multiple events.

In one embodiment, the UE can obtain the reporting configuration corresponding to each measurement identification according to the multiple measurement identifications indicated by the indication information, and each reporting configuration contains the configuration information of one measurement event.

In one embodiment, the UE can obtain the configuration information of one measurement event contained in each reporting configuration according to the identifications of the multiple reporting configurations indicated by the indication information.

In one embodiment, referring to FIG. 8, the embodiment of the present disclosure provides another information processing method, which includes:
Step S11, receiving first information sent by a network device, where the first information is used by a terminal to determine associated N measurement events, and N is an integer greater than 1;
Step S21, sending a measurement report to the network device according to the first information.

After receiving the first information, the terminal sends a measurement report to the network device according to the first information.

For the description of the first information, please refer to the embodiment.

This embodiment can be implemented alone or in combination with the embodiments shown in FIG. 2 to FIG. 7 above.

In one embodiment, the measurement report includes at least one of:
a measurement identification of the measurement to be performed;
a serving cell of the terminal; for example, the serving cell of the terminal includes a main serving cell and/or an auxiliary serving cell, etc.;
a neighboring cell with the best measurement result on each serving frequency point;
a neighboring cell that meets the triggering condition of the measurement event.

The network device can determine the measurement object corresponding to the measurement report, the threshold corresponding to the event-triggered measurement event, the periodic triggering purpose and the like according to the measurement identification in the measurement report and the measurement configuration information stored by the network device.

In one embodiment, after receiving the first information, the terminal performs measurement according to the first information to obtain the measurement result, and then sends the measurement report to the network device.

In one embodiment, referring to FIG. 9, FIG. 9 is a schematic diagram of another information processing method. The method includes:
Step S12, receiving first information sent by a network device, where the first information is used by a terminal to determine associated N measurement events, and N is an integer greater than 1;
Step S22, reporting a measurement report to the network device when the associated N measurement events meet a reporting condition.

For example, triggering the measurement reporting based on whether meeting the multiple (N) associated measurement events include:
in response to simultaneously meeting N measurement events (all N) or in response to meeting any measurement event or in response to simultaneously meeting X measurement events (X<N, X is configured by the network), it includes one or more of the following:
starting the measurement reporting, and/or
including a cell that meets N/1/X measurement events in a trigger cell list, and/or resetting a reporting counter, and/or
including a first entry of a corresponding measurement report in the UE variable storing the measurement report. The first entry is configured to record information that meets the measurement event.

For example, for a cell in which the measurement result meets one or more of the associated N measurement events, it is stored in a triggering cell list. The triggering cell list is a list of cells in which UE stores and meets one or more of the multiple associated measurement events.

This embodiment can be implemented alone or in combination with the embodiments shown in FIG. 2 to FIG. 8 above.

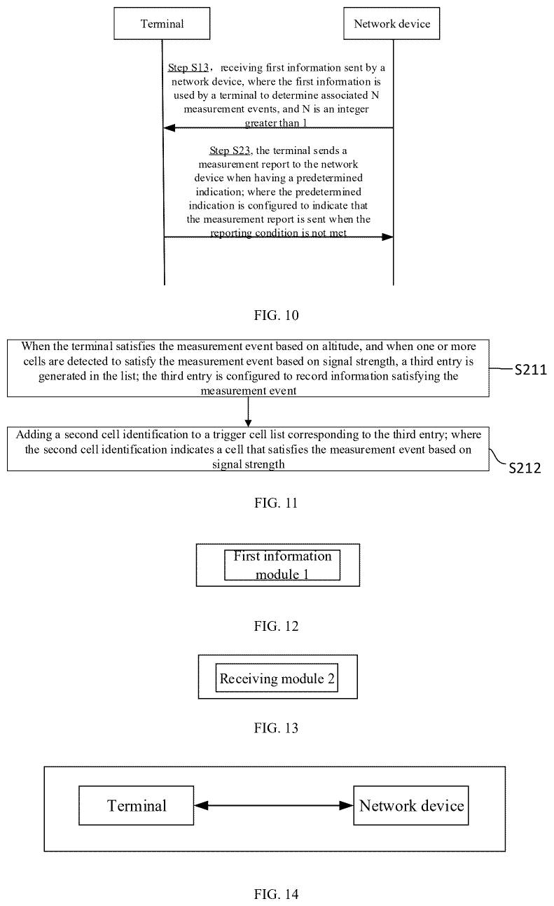

In one embodiment, referring to FIG. 10, FIG. 10 is a schematic diagram of another information processing method, the method includes:
Step S13, receiving first information sent by a network device, where the first information is used by a terminal to determine associated N measurement events, and N is an integer greater than 1;
Step S23, the terminal sends a measurement report to the network device when having a predetermined indication; where the predetermined indication is configured to indicate that the measurement report is sent when the reporting condition is not met.

For example, triggering the measurement reporting based on whether meeting the multiple (N) associated measurement events includes: in response to not meeting one of the measurement events (any one of the N) or in response to not meeting all the measurement events or in response to the number of measurement events that are met being less than X (X<N, X is configured by the network), it includes one or more of the following:
determining whether to trigger a measurement reporting according to a predetermined indication (reportonleave) on the network side, and/or
stopping the measurement reporting, and/or
stopping the corresponding periodic reporting timer, and/or
removing a cell that cannot simultaneously meet N/any one/X measurement events from the triggering cell list.

In one embodiment, for a cell in which a measurement result does not meet one or more of the associated N events, it is removed from the triggering cell list. When this list is empty, the UE releases the corresponding entry in the list (VarMeasReportList), where the list (VarMeasReportList) is configured to store the measurement configuration that meets the triggering condition.

This embodiment can be implemented alone or in combination with the embodiments shown in FIG. 2 to FIG. 8 above.

In one embodiment, N measurement events meeting the reporting condition, includes at least one of the following:
meeting any one of the N measurement events;
meeting all of the N measurement events;
meeting a predetermined number of events in the N measurement events.

In one embodiment, the method further includes:
storing a cell identification of a cell that meets at least one measurement event in the triggering cell list; where the triggering cell list is configured to store the identification of the cell that meets the measurement event.

The cell identification may include a physical cell identification. When the cell identification of the cell that meets at least one measurement event is stored in the triggering cell list, the cell identification stored in the triggering cell list may be reported simultaneously when reporting the measurement report.

In one embodiment, the method further includes:
in response to meeting the reporting condition, resetting a reporting counter; where the reporting counter is configured to count the number of times the measurement report is sent.

In one embodiment, the method further includes:
in response to meeting the reporting condition, adding a first entry for measurement; where the first entry is configured to record information that meets the measurement event.

The information that meets the measurement event includes the measurement identification, the identification of the measurement event and/or the cell identification, etc.

In one embodiment, not meeting the reporting condition includes at least one of the following:
not meeting any one of the N measurement events;
not meeting all of the N measurement events;
not meeting a predetermined number of events in the N measurement events.

In one embodiment, the method further includes at least one of the following:
stopping reporting the measurement report;
stopping reporting timer;
removing the cell identification of the cell that does not meet at least one measurement event from the trigger cell list.

In one embodiment, the method further includes:
when the trigger cell list is empty, deleting the entry corresponding to the trigger cell list in the list. Deleting the entry corresponding to the trigger cell list in the list includes deleting the first entry corresponding to the trigger cell list in the list.

In one embodiment, the measurement report includes:
one or more measurement identifications corresponding to the N associated measurement events;
and/or,
information of the satisfied measurement event.

The measurement event and the measurement identification include a one-to-one relationship and a many-to-one relationship. When the measurement event and the measurement identification include a one-to-one relationship, the measurement report includes multiple measurement identifications corresponding to the N associated measurement events. When the measurement event and the measurement identification include a many-to-one relationship, the measurement report includes one measurement identification corresponding to the N associated measurement events.

The information satisfying the measurement event includes the measurement identification, the identification of the measurement event, the identification of the reporting configuration and/or the cell identification, etc.

In one embodiment, the N measurement events include: one or more first type of measurement events; and one or more second type of measurement events. Each measurement event is a first type of measurement event and a second type of measurement event. The measurement event based on height can be used for terminals with height, such as aircraft, and the second type of measurement event is applied to cell. Height, speed, time and location are the height, speed, time and location of the terminal. The height includes relative height, such as a reference height based on sea level. The speed includes relative speed, the time includes relative time and absolute time, and the location includes relative location and absolute location, etc.

The N measurement events meeting the reporting condition includes:
the terminal satisfies the first type of measurement event and one or more cells measured satisfy the second type of measurement event;
or,
the terminal satisfies the first type of measurement event.
In one embodiment, not satisfying the reporting condition includes at least one of the following:
not satisfying the second type of measurement event;
the terminal does not satisfy the first type of measurement event.

In one embodiment, the method includes: when the terminal satisfies the first type of measurement event, creating a second entry in the list; the second entry is configured to record information satisfying the measurement event.

The information satisfying the measurement event includes the measurement identification, the identification of the measurement event, the identification of the reporting configuration and/or the cell identification, etc. The information satisfying the measurement event recorded in the second entry includes but is not limited to the information satisfying the measurement event of the signal strength.

This embodiment can be implemented alone or in combination with the embodiments shown in FIG. 2 to FIG. 10 above.

In one embodiment, the method includes adding a first cell identification to the triggering cell list corresponding to the second entry; where the first cell identification indicates a cell satisfying the second type of measurement event.

When the terminal meets the first type of measurement event, the first cell identification of the cell that meets the second type of measurement event is added to the trigger cell list corresponding to the second entry. The measurement result may include the cell corresponding to the first cell identification. The cell in the trigger cell list is used as the cell that triggers the reporting of the measurement report.

This embodiment can be implemented alone or in combination with the embodiments shown in FIG. 2 to FIG. 10 above.

In one embodiment, the method further includes:
in response to the cell corresponding to the first cell identification not meeting the second type of measurement event, the corresponding first cell identification is deleted from the trigger cell list.

In one embodiment, the method further includes:
in response to the terminal not meeting the first type of measurement event, deleting the second entry.

The second entry is generated in the list when the terminal meets the first type of measurement event, and the second entry is deleted when the terminal does not meet the first type of measurement event to reduce the occupied resources.

In one embodiment, if the first type of measurement event and the second type of measurement event are jointly configured (N=2), the triggering process of the measurement report includes one or more of the following:
In one embodiment, when the UE meets the first type of measurement event, a new second entry is included in the list, and the list (VarMeasReportList) is a list of information of the measurement that meets the triggering condition stored by the UE.

In one embodiment, the second entry corresponds to the measurement identification corresponding to the measurement event.

In one embodiment, the second entry corresponds to the measurement identification corresponding to the measurement event and its associated measurement identification, and the first type of measurement event and the second type of measurement event correspond to different measurement identifications.

In one embodiment, when one or more cells are detected to satisfy the second type of measurement event, and there is a corresponding second entry in the list, these related cells are included in the trigger cell list corresponding to the second entry.

In one embodiment, when one or more cells in the trigger cell list are detected not to satisfy the second type of measurement event, these related cells are deleted from the trigger cell list corresponding to the respective second entry.

In one embodiment, when the UE does not satisfy the first type of measurement event, the corresponding second entry is removed from the list.

In one embodiment, referring to FIG. 11, FIG. 11 is a schematic diagram of reporting a measurement report, step S21, reporting the measurement report to the network device when the associated N measurement events satisfy the reporting condition includes:
Step S211, when the terminal satisfies the first type of measurement event, and when one or more cells are detected to satisfy the second type of measurement event, a third entry is generated in the list; the third entry is configured to record information satisfying the measurement event.

Step S212, adding a second cell identification to a trigger cell list corresponding to the third entry; where the second cell identification indicates a cell that satisfies the second type of measurement event.

The cell corresponding to the second cell identification in the trigger cell list corresponding to the third entry is a cell that triggers the measurement report.

This embodiment can be implemented alone or in combination with the embodiments shown in FIG. 2 to FIG. 10 above.

In one embodiment, the method further includes:
in response to the cell corresponding to the second cell identification not satisfying the second type of measurement event, deleting the corresponding second cell identification from the trigger cell list.

In one embodiment, the method further includes:
in response to the trigger cell list being empty, deleting the third entry.

In one embodiment, if the first type of measurement event and the second type of measurement event are jointly configured, the triggering process of the measurement report may also include one or more of the following:
after the UE satisfies the first type of event, if the UE detects that one or more cells satisfy the second type of measurement event (such as for a first time), a new third entry is included in the list, and these cells are included in the trigger cell list corresponding to this entry. If the UE continues to detect that one or more cells satisfy the second type of measurement event (such as for a second time, a third time, etc.), these cells are included in the trigger cell list corresponding to the respective third entry.

In one embodiment, when it is detected that one or more cells in the trigger cell list do not satisfy the second type of measurement event, these related cells are removed from the trigger cell list corresponding to the respective third entry. If the trigger cell list is empty, the corresponding third entry is deleted.

In one embodiment, when the UE does not satisfy the first type of measurement event, the measurement reporting is stopped or the related measurement is stopped (without removing the corresponding third entry).

In one embodiment, if a predetermined indication is configured, then:
when it is detected that one or more cells in the trigger cell list do not satisfy the second type of measurement event, a measurement reporting is triggered; or
when the UE does not satisfy the first type of measurement event, a measurement reporting is triggered.

In one embodiment, the measurement event includes:
an entry condition, for the terminal to detect a parameter value that satisfies the measurement event within the configured trigger time and determine that the measurement event is satisfied;
and/or,
an exit condition, for the terminal to detect a parameter value that does not satisfy the measurement event within the configured trigger time and determine that the measurement event is not satisfied.

The trigger time, the parameter value that satisfies the measurement event, and the parameter value that does not satisfy the measurement event can be determined according to the actual use requirement, and can be determined according to the configuration parameters.

For example, satisfying measurement event means satisfying the entry condition of the corresponding measurement event within the configured trigger time,

For example, not satisfying measurement event means satisfying the exit condition of the corresponding measurement event within the configured trigger time.

In one embodiment, another information processing method is also provided, and the method includes:
a network device sends first information to a terminal, where the first information is used by the terminal to determine associated N measurement events, and N is an integer greater than 1;
the terminal receives the first information sent by the network device.

In one embodiment, another information processing method is also provided, including:
a network device sends first information to a terminal, where the first information is used by the terminal to determine associated N measurement events, and N is an integer greater than 1;
the terminal receives the first information sent by the network device;
the terminal sends a measurement report to the network device according to the first information;
the network device receives the measurement report sent by the terminal according to the first information.

In one embodiment, another information processing method is also provided, including:
a network device sends first information to a terminal, where the first information is used by the terminal to determine associated N measurement events, and N is an integer greater than 1;
the terminal receives the first information sent by the network device;
when the terminal meets a reporting condition, the terminal reports a measurement report to the network device;
the network device receives the measurement report sent by the terminal according to the first information.

In one embodiment, another information processing method is also provided, including:
a network device sends first information to a terminal, where the first information is used by the terminal to determine associated N measurement events, and N is an integer greater than 1;
the terminal receives the first information sent by the network device;
when the terminal has a predetermined indication, the terminal sends a measurement report to the network device; where the predetermined indication is configured to indicate that the measurement report is sent when the reporting condition is not met;
the network device receives the measurement report sent by the terminal according to the first information.

In one embodiment, referring to FIG. 12, FIG. 12 is a schematic diagram of an information processing device. The information processing device is applied to a network device, and the device includes:
a first information module 1 configured to send first information to a terminal, where the first information is used by the terminal to determine N associated measurement events, and N is an integer greater than 1.

The information processing device may include a second communication device.

The information processing device further includes a storage module. The storage module is connected to the first information module and is configured to store the first information.

In one embodiment, referring to FIG. 13, FIG. 13 is a schematic diagram of another information processing device. The information processing device is applied to a terminal, and the device includes:
a receiving module 2 configured to receive first information sent by a network device, where the first information is used by a terminal to determine N associated measurement events, and N is an integer greater than 1.

The information processing device may include a third communication device.

The information processing device further includes a storage module. The storage module is connected to the first information module and is configured to store the first information.

In one embodiment, referring to FIG. 14, FIG. 14 is a schematic diagram of a wireless communication system. The wireless communication system includes:
a network device 3, configured to send first information to a terminal, where the first information is used by the terminal to determine associated N measurement events, and N is an integer greater than 1;
a terminal 4, configured to receive the first information sent by the network device.

The embodiment of the present disclosure provides a communication device, including:
a memory for storing processor executable instructions;
a processor, respectively connected to the memory;
where the processor is configured to execute the information processing method provided by any of the aforementioned technical solutions.

The processor may include various types of storage media, which are non-transitory computer storage media, and can continue to store information stored thereon after the communication device is powered off.

Here, the communication device includes UE.

The processor can be connected to the memory through a bus, etc., for reading an executable program stored on the memory, for example, at least one of the methods shown in FIG. 2 to FIG. 11.

In the related art, only measurement reporting triggered by a single measurement event is supported, and one measurement identification is associated with one reporting configuration and one measurement object. Only one event can be configured in a reporting configuration, so the existing measurement configuration cannot support triggering measurement reporting through the joint configuration of multiple events. How to implement the joint configuration of multiple events needs to be clarified.

The first type of measurement reporting event is introduced for unmanned aerial vehicles (UAVs). Secondly, there are also measurement reporting events based on location information for mobile terminals. The first type of measurement event needs to be evaluated based on the current height, speed, time and/or location of the UE, but the second type of measurement event is evaluated based on the measurement results of the cell measured by the UE, and the objects of evaluation are different. The embodiment of the present disclosure proposes a measurement method suitable for the joint of multiple events. First, a configuration implementation suitable for the joint of multiple events is proposed to support the UE to trigger measurement reporting according to multiple events (or conditions). And the method of triggering measurement reporting and starting measurement when the first type of measurement event and the second type of measurement event are jointly configured is clarified.

The embodiment of the present disclosure includes the following contents:
the UE receives measurement configuration information sent by the network side, where the configuration information includes measurement configuration information associated with multiple measurement events, and the UE triggers measurement reporting based on the measurement configuration information. For the measurement configuration associated with multiple measurement events, the UE triggers measurement reporting based on whether satisfying the associated multiple events.

In one embodiment, the measurement configuration information includes one or more of the following information:
a measurement identification;
a reporting configuration;
a measurement object;
indication information, configured to indicate one or more associated measurement events.

In one embodiment, the joint configuration of multiple measurement events can be realized by associating multiple reporting configurations with one measurement identification, where each reporting configuration corresponds to one measurement event and multiple reporting configurations are associated with one measurement identification.

In one embodiment, a group of joint configuration information includes one measurement identification, multiple reporting configurations and one measurement object. One measurement identification can associate multiple reporting configurations with one measurement object.

In one embodiment, one measurement identification is associated with one measurement object and one group of reporting configurations.

In one embodiment, one measurement identification is associated with one measurement object and two reporting configurations. The association here includes direct association or indirect association.

In one embodiment, the measurement identification may be a measurement identification dedicated to configuring the joint configuration of multiple measurement events.

In one embodiment, the joint configuration of multiple measurement events may be implemented by including the configuration of multiple measurement events in one reporting configuration.

In one embodiment, a group of joint configuration information includes one measurement identification, one reporting configuration and one measurement object. The measurement identification associates one reporting configuration with one measurement object. The reporting configuration may include the configuration of multiple measurement events.

In one embodiment, one reporting configuration may include the configuration information of a group of measurement events.

In one embodiment, one reporting configuration may include the configuration information of two measurement events.

In one embodiment, for example, one event is a second type of measurement event, and one event is a first type of measurement event.

In one embodiment, the joint configuration of multiple measurement events may be implemented by indication information, and the indication information may be configured to indicate one or more associated measurement events, including at least one of the following:
the indication information indicates one or more measurement identifications;
the indication information indicates identifications of one or more reporting configurations;
the indication information includes identifications or configurations of one or more events.

For the indication information, the identifications of the multiple reporting configurations used for indication are all associated with the same measurement object.

For the indication information, the multiple measurement identifications used for indication are all associated with the same measurement object and different reporting configurations.

In one embodiment, if the joint configuration of multiple measurement events involves multiple measurement identifications, that is, each measurement identification corresponds to configuration of one measurement event, then each entry in a list corresponds to multiple measurement identifications, where the list is a list of information of measurements that meet the triggering conditions stored by UE. That is, each entry contains multiple measurement identifications, which can be achieved by a group of measurement identification lists. If N=2, it contains two measurement identifications. The list may be, but not limited to, VarMeasReportList. The entry may be, but not limited to, VarMeasReport.

In one embodiment, the UE may determine the associated multiple measurement events according to any configuration method of the above embodiments.

In one embodiment, for a measurement identification, if it is associated with multiple reporting configurations, the configuration information of the corresponding measurement event may be obtained according to each reporting configuration.

In one embodiment, the UE may obtain the configuration information of the corresponding measurement event according to the reporting configuration containing the configuration information of multiple measurement events.

In one embodiment, the UE may obtain the reporting configuration corresponding to each measurement identification according to the multiple measurement identifications indicated by the indication information, and each reporting configuration contains configuration information of one measurement event.

In one embodiment, the UE can obtain the configuration information of a measurement event contained in each reporting configuration according to the identifications of multiple reporting configurations indicated by the indication information.

In one embodiment, triggering the measurement reporting based on whether meeting the associated multiple (N) measurement events includes:
in response to simultaneously meeting N measurement events (all N) or in response to meeting any measurement event or in response to simultaneously meeting X measurement events (X<N, X network configuration), it includes one or more of the following:
starting the measurement reporting, and/or
including a cell that meets N/1/X measurement events in a triggering cell list, and/or
resetting a reporting counter, and/or
including a first entry of a corresponding measurement report in the UE variable storing the measurement report. The first entry is configured to record information that meets the measurement event.

In one embodiment, triggering the measurement reporting based on whether meeting the associated multiple (N) measurement events includes: in response to not meeting one of the measurement events (any one of the N) or in response to not meeting all the measurement events or in response to the number of measurement events that are met being less than X (X<N, X is configured by the network), it includes one or more of the following:
determining whether to trigger a measurement reporting according to a predetermined indication (reportonleave) on the network side, and/or
stopping the measurement reporting, and/or
stopping the corresponding periodic reporting timer, and/or
removing a cell that cannot simultaneously meet N/any one/X measurement events from the trigger cell list.

In one embodiment, for a cell in which a measurement result meets one or more of the associated N events, it is stored in a trigger cell list, where the trigger cell list is a list of cells that meet one or more of the associated multiple measurement events stored by UE.

In one embodiment, for a cell in which a measurement result does not meet one or more of the associated N measurement events, it is removed from the trigger cell list. When this list is empty, the UE releases the corresponding entry in the list (VarMeasReportList), where the list (VarMeasReportList) is configured to store the measurement configuration that meets the triggering condition.

In one embodiment, the UE starts the measurement reporting. That is, the UE sends a measurement report to the network. The measurement report contains one or more measurement identifications corresponding to the multiple measurement events configured jointly and/or indication information for indicating the measurement event currently met. If the measurement reporting is triggered by a predetermined indication on the network side, the measurement report indicates the measurement reporting is triggered by which one or more events are not met or indicates that the measurement reporting is triggered by a predetermined indication on the network side.

In one embodiment, if the first type of measurement event and the second type of measurement event (N=2) are jointly configured, the triggering process of the measurement reporting includes one or more of the following:
in one embodiment, when the UE meets the first type of measurement event, a new second entry is included in the list, where the list (VarMeasReportList) is a list of information of measurements that meet the trigger condition stored by UE.

In one embodiment, this second entry corresponds to the measurement identification corresponding to this measurement event.

In one embodiment, the second entry corresponds to the measurement identification corresponding to the measurement event and its associated measurement identification, and the first type of measurement event and the second type of measurement event correspond to different measurement identifications)

In one embodiment, when one or more cells are detected to satisfy the second type of measurement event, and there is a corresponding second entry in the list, these related cells are included in the trigger cell list corresponding to the second entry.

In one embodiment, when one or more cells in the trigger cell list are detected to not satisfy the second type of measurement event, these related cells are deleted from the trigger cell list corresponding to the respective second entry.

In one embodiment, when the UE does not satisfy the first type of measurement event, the corresponding second entry is removed from the list.

In one embodiment, if the first type of measurement event and the second type of measurement event are jointly configured (N=2), the triggering process of the measurement reporting may also include one or more of the following:
After the UE satisfies the first type of event, if the UE detects that one or more cells satisfy the second type of measurement event (satisfy for a first time), a new third entry is included in the list, and these cells are included in the trigger cell list corresponding to this entry. If the UE continues to detect that one or more cells satisfy the second type of measurement event (satisfy for a second time, a third time, etc.), these cells are included in the trigger cell list corresponding to the respective third entry.

In one embodiment, when it is detected that one or more cells in the trigger cell list do not satisfy the second type of measurement event, these related cells are removed from the trigger cell list corresponding to the corresponding third entry. If the trigger cell list is empty, the corresponding third entry is deleted.

In one embodiment, when the UE does not satisfy the first type of measurement event, the measurement reporting is stopped or the related measurement is stopped (without removing the corresponding third entry).

In one embodiment, if a predetermined indication is configured, then:
when it is detected that one or more cells in the trigger cell list do not satisfy the second type of measurement event, a measurement reporting is triggered; or
when the UE does not satisfy the first type of measurement event, a measurement reporting is triggered.

In one embodiment, satisfying the measurement event means that an entry condition of the corresponding measurement event is satisfied within the configured trigger time, and not satisfying the measurement event means that an exit condition of the corresponding measurement event is satisfied within the configured trigger time. The entry condition is used for the terminal to detect a parameter value that satisfies the measurement event within the configured trigger time, and determine that the measurement event is satisfied. The exit condition is used for the terminal to detect a parameter value that does not satisfy the measurement event within the configured trigger time, and determine that the measurement event is not satisfied.

FIG. 16 is a block diagram of a UE 800 shown according to an example embodiment. For example, UE 800 may be a mobile phone, a computer, a digital broadcast user device, a messaging device, a game console, a tablet device, a medical device, a fitness device, a personal digital assistant, etc.

In RRC_CONNECTED, the UE measures multiple beams (at least one) of a cell and the measurements results (power values) are averaged to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving cell(s). Measurement reports may contain the measurement results of the X best beams if the UE is configured to do so by the gNB.

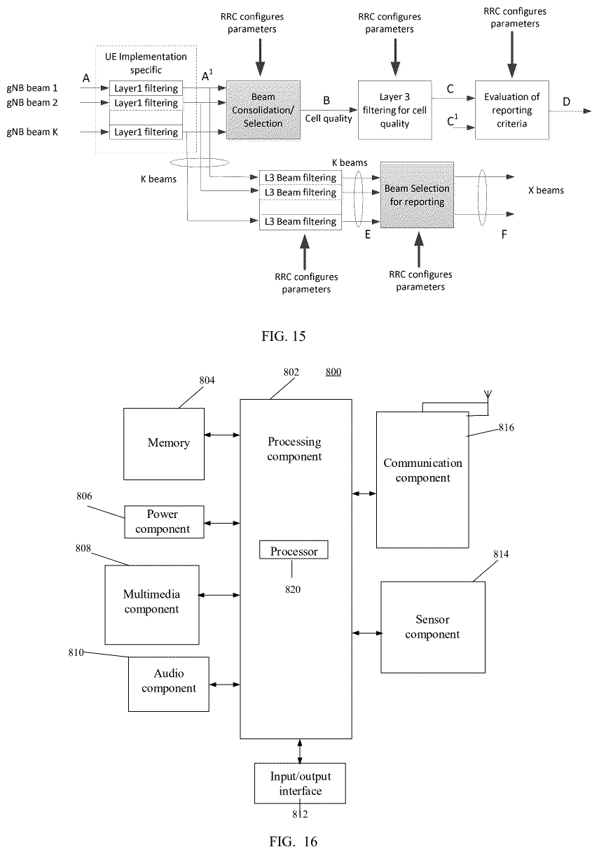

The corresponding high-level measurement model is as shown in FIG. 15. In FIG. 15, K beams correspond to the measurements on SSB or CSI-RS resources configured for L3 mobility by gNB and detected by UE at L1. A shows measurements (beam specific samples) internal to the physical layer. A¹ shows measurements (i.e. beam specific measurements) reported by layer 1 to layer 3 after layer 1 filtering. Beam specific measurements are consolidated to derive cell quality. B show a measurement (i.e. cell quality) derived from beam-specific measurements reported to layer 3 after beam consolidation/selection. Filtering is performed on the measurements provided at point B. C shows a measurement after processing in the layer 3 filter. Check whether actual measurement reporting is necessary at point D. The evaluation can be based on more than one flow of measurements at reference point C e.g. to compare between different measurements. This is illustrated by input C and C¹. The UE shall evaluate the reporting criteria at least every time a new measurement result is reported at point C, C¹. D shows measurement report information (message) sent on the radio interface. L3 beam filtering is performed on the measurements (i.e. beam specific measurements) provided at point A¹. E shows a measurement (i.e. beam-specific measurement) after processing in the beam filter. Select the X measurements from the measurements provided at point E. F shows beam measurement information included in measurement report (sent) on the radio interface.

Referring to FIG. 16, UE 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of UE 800, such as operations associated with display, phone calls, data communications, camera operations, and recording operations. The processing component 802 may include one or more processors 820 to execute instructions to generate all or part of the steps of the above-mentioned method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations in UE 800. Examples of such data include instructions for any application or method operating on UE 800, contact data, phonebook data, messages, pictures, videos, etc. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of UE 800. The power component 806 may include a power management system, one or more power supplies, and other components associated with generating, managing and distributing power for UE 800.

The multimedia component 808 includes a screen that provides an output interface between the UE 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor can sense not only the boundary of the touch or sliding action, but also the duration and pressure associated with the touch or sliding operation. In some embodiments, the multimedia component 808 includes a front camera and/or a rear camera. When the UE 800 is in an operating mode, such as a shooting mode or a video mode, the front camera and/or the rear camera can receive external multimedia data. Each front camera and rear camera can be a fixed optical lens system or have a focal length and optical zoom capability.

The audio component 810 is configured to output and/or input audio signals. For example, the audio component 810 includes a microphone (MIC), which is configured to receive external audio signals when the UE 800 is in an operating mode, such as a call mode, a recording mode, and a voice recognition mode. The received audio signal can be further stored in the memory 804 or sent via the communication component 816. In some embodiments, the audio component 810 also includes a speaker for outputting audio signals.

The I/O interface 812 provides an interface between the processing component 802 and the peripheral interface module. The peripheral interface can be a keyboard, a click wheel, a button, etc. These buttons may include, but are not limited to, a home button, a volume button, a start button, and a lock button.

The sensor component 814 includes one or more sensors for providing various aspects of status assessment for the UE 800. For example, the sensor component 814 can detect the open/closed state of the device 800, the relative positioning of components, such as the display and keypad of the UE 800. The sensor component 814 can also detect the position change of the UE 800 or a component of the UE 800, the presence or absence of user contact with the UE 800, the orientation or acceleration/deceleration of the UE 800, and the temperature change of the UE 800. The sensor component 814 may include a proximity sensor configured to detect the presence of nearby objects without any physical contact. The sensor component 814 may also include an optical sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 can access a wireless network based on a communication standard, such as WiFi, 2G or 3G, or a combination thereof. In an example embodiment, the communication component 816 receives a broadcast signal or broadcast-related information from an external broadcast management system via a broadcast channel. In an example embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an example embodiment, UE 800 can be implemented by one or more of an application-specific integrated circuit (ASIC), a digital signal processor (DSP), a digital signal processing device (DSPD), a programmable logic device (PLD), a field programmable gate array (FPGA), a controller, a microcontroller, a microprocessor or other electronic components to perform the above method.

In an example embodiment, a non-transitory computer-readable storage medium including instructions is also provided, such as a memory 804 including instructions, and the above instructions can be executed by the processor 820 of the UE 800 to generate the above method. For example, the non-transitory computer-readable storage medium can be a ROM, a random access memory (RAM), a CD-ROM, a magnetic tape, a floppy disk, and an optical data storage device, etc.

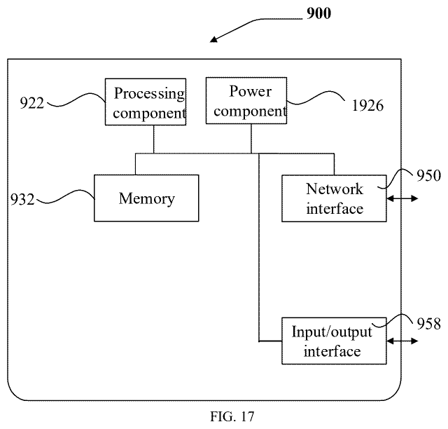

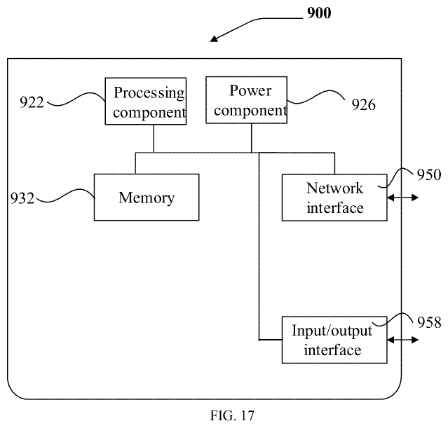

As shown in FIG. 17, an embodiment of the present disclosure shows a structure of an access device. For example, the communication device 900 can be provided as a network-side device. The communication device may be various network elements such as the aforementioned access network element and/or network function.

Referring to FIG. 17, the communication device 900 includes a processing component 922, which further includes one or more processors, and a memory resource represented by a memory 932 for storing instructions executable by the processing component 922, such as an application. The application stored in the memory 932 may include one or more modules each corresponding to a set of instructions. In addition, the processing component 922 is configured to execute instructions to perform any method of the aforementioned method applied to the access device, for example, as shown in any one of FIG. 4 to FIG. 9.

The communication device 900 may further include a power component 926 configured to perform power management of the communication device 900. A wired or wireless network interface 950 is configured to connect the communication device 900 to a network, and an input/output (I/O) interface 958. The communication device 900 may operate based on an operating system stored in the memory 932, such as Windows Server™, Mac OS X™, Unix™) Linux™, FreeBSD™, or the like.

A person skilled in the art will easily come up with other embodiments of the embodiments of the present disclosure after considering the specification and practicing the present disclosure herein. The present disclosure is intended to cover any variation, use or adaptation of the embodiments of the present disclosure, which follows the general principles of the embodiments of the present disclosure and includes common knowledge or customary technical means in the technical field not disclosed in the present disclosure. The specification and embodiments are to be regarded as exemplary only, and the true scope and spirit of the disclosed embodiments are indicated by the following claims.

It should be understood that the embodiments of the present disclosure are not limited to the precise structures described above and shown in the accompanying drawings, and various modifications and changes can be made without departing from the scope thereof. The scope of the embodiments of the present disclosure is limited only by the appended claims.

1. An information processing method, performed by a network device, comprising:
sending first information to a terminal, wherein the first information is used by the terminal to determine N associated measurement events, and N is an integer greater than 1.

2. The method according to claim 1, wherein the first information comprises:
first measurement configuration information, wherein one piece of the first measurement configuration information comprises configuration information of the N measurement events; or
indication information, for indicating an association between M pieces of second measurement configuration information, wherein one piece of the second measurement configuration information comprises configuration information of one measurement event; and M is an integer greater than 1.

3. The method according to claim 2, wherein the first measurement configuration information comprises:
a measurement identification;
an identification of a measurement object;
an identification of a reporting configuration group; wherein one reporting configuration group comprises N reporting configurations, and one reporting configuration corresponds to one measurement event.

4. The method according to claim 2, wherein the first measurement configuration information further comprises:
a measurement identification;
an identification of a measurement object;
an identification of a reporting configuration; wherein one reporting configuration corresponds to the N measurement events.

5. The method according to claim 1, wherein the measurement event comprises at least one of:
a first type of measurement event or a second type of measurement event,
wherein the first type of measurement event comprises at least one of:
a measurement event based on height;
a measurement event based on speed;
a measurement event based on time;
a measurement event based on location,
wherein the second type of measurement event at least comprises:
a measurement event based on signal strength.

6.-7. (canceled)

8. The method according to claim 2, wherein the indication information comprises:
N measurement identifications; wherein one measurement identification is associated with one measurement event, and N measurement events associated with the N measurement identifications in the same indication information are associated; or
N reporting configuration identifications, one reporting configuration identification is associated with one measurement event, and N measurement events associated with the N reporting configuration identifications in the same indication information are associated; or
N measurement event identifications; N measurement events indicated by the N measurement event identifications in the same indication information are associated; or
configuration information of N measurement events; measurement events indicated by the configuration information of N measurement events in the same indication information have a relationship.

9. The method according to claim 1, further comprising:
receiving a measurement report sent by the terminal according to the first information, wherein receiving the measurement report sent by the terminal according to the first information comprises:
receiving the measurement report reported by the terminal when a reporting condition is met; or
receiving the measurement report sent by the terminal when the terminal has a predetermined indication; wherein the predetermined indication is configured to indicate that the measurement report is sent when the reporting condition is not met,
wherein meeting the reporting condition comprises at least one of:
meeting any one of the N measurement events;
meeting all of the N measurement events;
meeting a predetermined number of events in the N measurement events, wherein not meeting the reporting condition comprises at least one of:
not meeting any one of the N measurement events;
not meeting all of the N measurement events;
not meeting a predetermined number of events in the N measurement events.

10.-12. (canceled)

13. The method according to claim 11, wherein the N measurement events comprise: one or more first type of measurement events; and one or more second type of measurement events;
meeting the reporting condition comprises:
the terminal meets the first type of measurement event, and measured one or more cells meet the second type of measurement event; or
the terminal meets the first type of measurement event,
wherein not meeting the reporting condition comprises at least one of:
not meeting the second type of measurement event;
the terminal does not meet the first type of measurement event.

14.-16. (canceled)

17. The method according to claim 1, wherein the measurement event comprises at least one of:
an entry condition, for the terminal to detect a parameter value that meets the measurement event within configured trigger time, and determine that the measurement event is met; or
an exit condition, for the terminal to detect a parameter value that does not meet the measurement event within configured trigger time, and determine that the measurement event is not met.

18. An information processing method, performed by a terminal, comprising:
receiving first information sent by a network device, wherein the first information is used by the terminal to determine associated N measurement events, and N is an integer greater than 1.

19. The method according to claim 18, wherein the first information comprises:
first measurement configuration information, wherein one piece of the first measurement configuration information comprises configuration information of the N measurement events; or
indication information, configured to indicate an association between M pieces of second measurement configuration information, wherein one piece of the second measurement configuration information comprises configuration information of one measurement event; M is an integer greater than 1.

20. The method according to claim 19, wherein the first measurement configuration information comprises:
a measurement identification;
an identification of a measurement object;
an identification of a reporting configuration group; wherein one reporting configuration group comprises N reporting configurations, and one reporting configuration corresponds to one measurement event,
and wherein determining the associated N measurement events comprises:
determining corresponding N measurement events according to each of the reporting configurations, or
wherein the first measurement configuration information further comprises:
a measurement identification;
an identification of a measurement object;
an identification of a reporting configuration, indicating one reporting configuration;
wherein one reporting configuration corresponds to the N measurement events,
and wherein determining the associated N measurement events comprises:
determining the associated N measurement events according to the reporting configuration associated with the N measurement events.

21.-27. (canceled)

28. The method according to claim 18, further comprising:
sending a measurement report to the network device according to the first information,
wherein sending the measurement report to the network device according to the first information comprises:
reporting the measurement report to the network device when a reporting condition is met; or
sending the measurement report to the network device when the terminal has a predetermined indication; wherein the predetermined indication is configured to indicate that the measurement report is sent when the reporting condition is not met.

29.-30. (canceled)

31. The method according to claim 28, further comprising at least one of:
storing a cell identification of a cell that meets at least one of the measurement events in a trigger cell list; wherein the trigger cell list is configured to store identification of the cell that meets the measurement event;
resetting a reporting counter in response to meeting the reporting condition;
wherein the reporting counter is configured to count a number of times the measurement report is sent;
adding a first entry for measurement in response to meeting the reporting condition;
wherein the first entry is configured to record information that meets the measurement event,
wherein the method further comprises at least one of:
stopping reporting the measurement report;
stopping the reporting timer;
removing the cell identification of the cell that does not meet at least one of the measurement events from the trigger cell list,
when the trigger cell list is empty, deleting an entry corresponding to the trigger cell list in the list.

32.-34. (canceled)

35. The method according to claim 28, wherein the measurement report comprises at least one of:
one or more measurement identifications corresponding to the N associated measurement events; or
information of the measurement event that is met.

36. The method according to claim 28, wherein the N measurement events comprise one or more first type of measurement events; and one or more second type of measurement events;
the N measurement events meeting the reporting condition comprises:
the terminal meets the first type of measurement event and measured one or more cells meet the second type of measurement event; or
the terminal meets the first type of measurement event,
wherein not meeting the reporting condition comprises at least one of:
not meeting the second type of measurement event;
the terminal does not meet the first type of measurement event.

37. (canceled)

38. The method according to claim 28, further comprising:
when the terminal meets the first type of measurement event, generating a second entry in a list; the second entry is configured to record information that meets the measurement event,
adding a first cell identification to a trigger cell list corresponding to the second entry; wherein the first cell identification indicates a cell that meets the second type of measurement event,
in response to a cell corresponding to the first cell identification not meeting the measurement event based on the signal strength, deleting the corresponding first cell identification from the trigger cell list,
in response to the terminal not meeting the first type of measurement event, deleting the second entry.

39.-41. (canceled)

42. The method according to claim 28, wherein reporting the measurement report to the network device when the associated N measurement events meet the reporting condition comprises:
when the terminal meets the first type of measurement event and detects that one or more cells meet the second type of measurement event, generating a third entry in a list;
adding a second cell identification to a trigger cell list corresponding to the third entry; wherein the second cell identification indicates a cell that meets the second type of measurement event;
in response to the trigger cell list being empty, deleting the third entry,
in response to a cell corresponding to the second cell identification not meeting the measurement event based on the signal strength, deleting the corresponding second cell identification from the trigger cell list.

43.-49. (canceled)

50. A communication device, comprising a processor, a transceiver, a memory, and an executable program stored in the memory and capable of being run by the processor, wherein when running the executable program, the processor is configured to:
send first information to a terminal, wherein the first information is used by the terminal to determine N associated measurement events, and N is an integer greater than 1.

51. (canceled)

52. A communication device, comprising a processor, a transceiver, a memory, and an executable program stored in the memory and capable of being run by the processor, wherein the processor executes the information processing method according to claim 18 when running the executable program.
